(19) United States
(12) Patent Application Publication
(10) Pub. No.: US 2007/0203744 A1
(43) Pub. Date: Aug. 30, 2007

(54) Clinical workflow simulation tool and method

(76) Inventor: Stefan Scholl, Nuernberg (DE)

Correspondence Address: SCHIFF HARDIN, LLP;PATENT DEPARTMENT, 6600 SEARS TOWER, CHICAGO, IL, 60606-6473, US

(21) Appl. No.: 11/363,919

(22) Filed: Feb. 28, 2006

(51) Int. Cl. G06Q 10/00; G06F 3/048

(52) U.S. Cl. 705/2; 715/848

(57) ABSTRACT

The present method and system provides a simulation of a clinical workflow in a healthcare facility which models the processes and treatment of patients at a healthcare facility and enables various processes to be compared and shown in interaction with one another. Actual data from the healthcare facility is provided as input. Proposals for changing the performance parameters in the re-engineered processes may be measured.

### BACKGROUND OF THE INVENTION

1. Field of the Invention

The present invention relates generally to a workflow simulation and in particular to a method for simulating workflow in a healthcare institution.

2. Description of the Related Art

The healthcare industry is under considerable pressure to improve performance and reduced costs. The healthcare facilities must be always be mindful of costs, resource utilization, timeliness of care, and efficiency of processes. In order to address issues in this area, consultants are generally hired to work with a healthcare facility to improve specific situations at the facility. Based on individual and facility specific workflow analysis, proposals for improvement are presented to the facility as a typical result of the project. The consulting project requires highly skilled people with process and medical knowledge and specific tools in order to accomplish the desired goals. The impact of changes in the processes and in the workflow on the operational and financial state of the healthcare facility is often based on an estimation utilizing standard parameters such as reimbursements rates, human resource costs, equipment and material costs, maintenance costs and the like, which are not considered as a dynamic interaction between different processes and workflows.

A healthcare facility needs a method and tool to provide a measure of a proposed change in a clinical workflow process before investing in infrastructure and re-engineering of processes.

### SUMMARY OF THE INVENTION

The present invention generally provides a workflow simulation tool and method by which healthcare facility specific processes and workflows are simulated and quantified. Operational and financial parameters of the processes and workflows of a specific healthcare facility are measured. Changes are proposed in the processes and workflows and a comparison of the parameters is performed before and after implementation of the proposed changes as a simulation of the processes and workflows. The comparison is applied to the specific site plan of the healthcare facility so that the effects of interactions between different processes and workflows becomes apparent. A goal is to optimize the clinical, operational, and financial performance of the healthcare facility.

### BRIEF DESCRIPTION OF THE DRAWINGS

FIG. 1 is a schematic representation of a workflow example for a healthcare facility for treatment of a patient with acute myocardial infarction, the workflow focusing on performing a percutaneous transluminal coronary angioplasty therapy;

FIG. 2 is a schematic representation of modules utilized in the angioplasty procedure of FIG. 1;

FIGS. 3a and 3b are graphical representations of modules utilized in a therapy of FIG. 2, for example;

FIG. 4 is a schematic representation of the modules utilized in the therapy process as it is transformed for implementation in the clinical workflow simulation tool;

FIG. 5 is a schematic representation of a measure of a parameter utilizing the workflow defined in the workflow simulation tool;

FIG. 6 is a schematic representation of the process portion of the workflow shown in FIG. 5 and utilizing the parameter definitions;

FIG. 7 is a collection of floor plan portions for specific healthcare units to be utilized in the workflow simulation according to the principles of the present invention;

FIG. 8 is a graphical representation of a parameter analysis utilizing the clinical workflow simulation tool to model the healthcare facility; and

FIG. 9 is a graphical representation of a parameter analysis by the clinical workflow simulation tool after entry of proposed modifications for the healthcare facility.

### DETAILED DESCRIPTION OF THE PREFERRED EMBODIMENTS

The present invention provides a method and tool for simulation of clinical workflow in a healthcare facility in order to quantify specific facility processes and workflows. Measures of operational and financial parameters are obtained and the operational and financial parameters are compared both before and after proposed changes in the processes and workflows. In order to input the data into the method and tool, the input information is obtained much the same way as with consulting projects for a healthcare facility. In particular, specific questions are raised such as, “what are the costs of clinical services such as operating rooms or stroke units”, “what are the benchmarks to compare these costs with,” “what are the actions and changes that should be implemented”, and “what are the consequences of these changes”. With these questions, parameters are defined such as costs per case, utilization rate for the operating theater, the number of nurses per case, the time for specific procedures, the transportation times, and the like. The data for the specific healthcare facility environment is measured. Examples of the measurements include that an analysis of the cost structure for the facility, a count of how many cases are handled in a specific area or during specific period of time, the number of nurses compared to the number of cases in specific time periods, how long a specific procedure runs in a specific time period, how long it takes for transportation of a patient from one point to another, etc.

The gathering of data is by answering the questions raised and defining and measuring the parameters which effect that question. Other data gathering is also possible. In order to implement the present method, specific data is required, such as measurements of the times needed for a nurse or a physician or technician to go to from one point to the next at the health care facility. The patient preparation time is determined, the day and night shift timed differences are determined, and the hospital layout is input. The data is gathered by conducting measurements in the healthcare facility environment during real world operations, for example, by either an outside consultant or by dedicated data gathering personnel. This type of data is not typically used in a consulting project but is utilized according to the present simulation tool.

The data input portion of the present method utilizes a map to process the input into the system in order to map the client hospital or health care facility layout to the processes and assign resources to the process steps as well as to give time periods for the process steps, assign work places to the process steps, assign patients to the process steps, and define the interferences in the process.

In one embodiment, the simulation tool is a software program or set of programs that is operable on a computer and that is stored on computer readable media. The computer or computer system accepts inputs and performs the simulation and provides outputs by standard computer hardware and software. The computer may be a stand-alone computer or may be connected to a network. More than one computer may be used, with different functions being performed by different computers.

In a preferred embodiment, the clinical workflow simulation tool and method provides patient and client processes like ARIS along with resource lists of human, technical and infrastructure resources, information on worker shifts, costs of defined resources, capacities for the resources, interferences between the processes, and resources at the specific healthcare facility user interface.

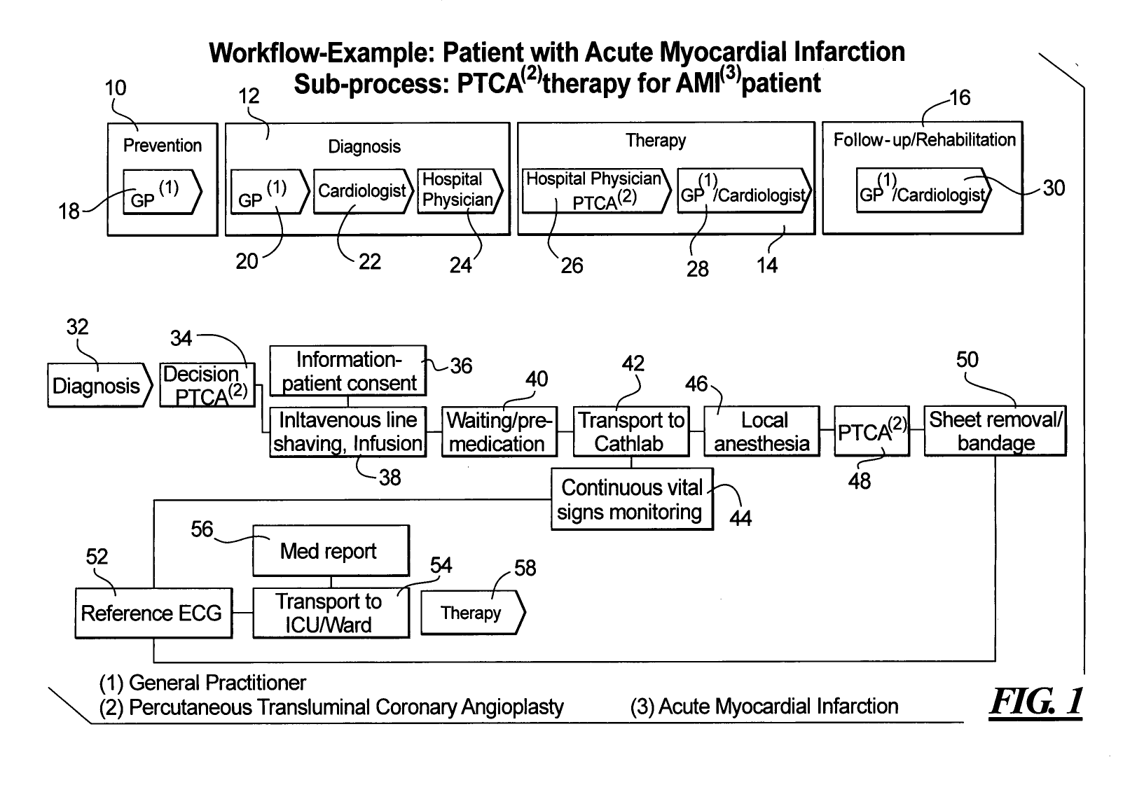

The collected data is used to generate a clinical workflow as shown in FIG. 1. The clinical workflow illustrates the workflow processes for a healthcare facility for a patient with acute myocardial infarction (AMI) who is to be treated by percutaneous transluminal coronary angioplasty (PTCA). The upper portion of the illustration shows the major stages of the process including prevention 10, diagnosis 12, therapy 14, and follow-up and rehabilitation 16. The personnel who oversee processing in each major stage are indicated in each stage block. For instance, the prevention stage 10 is carried out under the authority of the general practitioner, indicated as GP in the drawing. The diagnosis stage 12 begins with the general practitioner at 20, consultation is carried out with a cardiologist at 22 and then the matter is referred to a hospital physician at 24. The therapy stage 14 is initiated by the hospital physician who carries out the PCTA and following the PCTA procedure the patient responsibility is transferred to the general practitioner or cardiologist or at least consultation is carried out with these doctors at 28. The follow-up and rehabilitation stage 16 is the responsibility of the general practitioner and cardiologist at 30. The illustrated stages include process steps for each of the parts in the main process stages. For example, the therapy stage 14 by the hospital physician who performs the angioplasty includes the steps indicated in the lower portion of FIG. 1 wherein the therapy stage is begun with diagnosis 32, followed by a decision to perform the percutaneous transluminal coronary angioplasty (PCTA) at 34. This is followed by providing information to the patient and obtaining patient consent at 36 and installation of an intravenous line, shaving the patient and beginning infusion at 38. Thereafter, a step of waiting and pre-medication 40 is an element to be considered in the process. The patient is then transported to the cathlab (catheter laboratory) at 42. At this time, there is a continuous monitoring of vital signs as indicated at 44. Once in the cathlab, a local anesthesia is applied at 46, and the percutaneous transluminal coronary angioplasty is performed at 48. Following the angioplasty procedure, the operating sheets or drapes are removed and the patient is bandaged at 50. A reference ECG (Electro-Cardio Gram) is then taken at 52. Following the ECG, the vital signs monitoring 44 is ceased. The conclusion of this stage of the therapy includes the transportation of the patient to the intensive care unit (ICU) at 54 and preparation of a medical report at 56. The therapy then continues as indicated at 58.

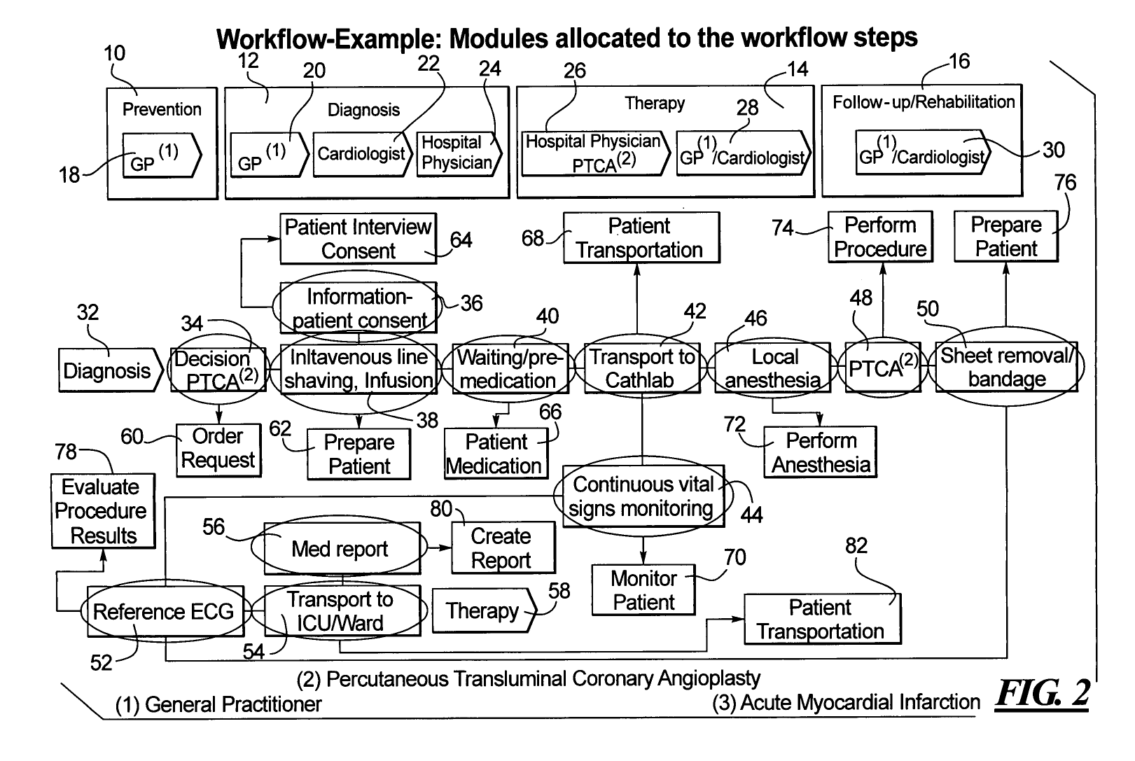

With reference to FIG. 2, the patient treatment steps may be clustered in modules. Each module is an instantiation in the clinical patient workflow. In FIG. 2, the primary stages 10-16 are identical to those of FIG. 1. The steps performed under the authority of the hospital physician PTCA part are indicated in the lower portion of FIG. 2. For example, the decision to perform the PTCA 34 has allocated to an order request module 60. The intravenous line insertion, shaving of the patient, and infusion of intravenous fluids at step 38 is allocated to prepare the patient module 62. Substantially simultaneously thereto, the inform the patient and patient consent step 36 has allocated to it a patient interview consent module 64. The waiting and pre-medication step 40 has a patient medication module 66 allocated to it. The transport to cathlab step 42 has allocated to it a patient transportation module 68. The vital signs monitoring steps 44 has a monitor the patient module 70 allocated to it. The local anesthesia step 46 includes a module to perform the anesthesia at 72. The PTCA step 48 includes a perform the procedure module at 74. The sheet removal and bandaging step 50 includes a prepare the patient module 76. In the reference ECG step 52 is provided an evaluate procedure results module 78. The medical report step 56 includes a create report module 80 while the transport to intensive care unit step 54 includes a patient transport module 82, which may be the same or a similar module as the patient transport module 68.

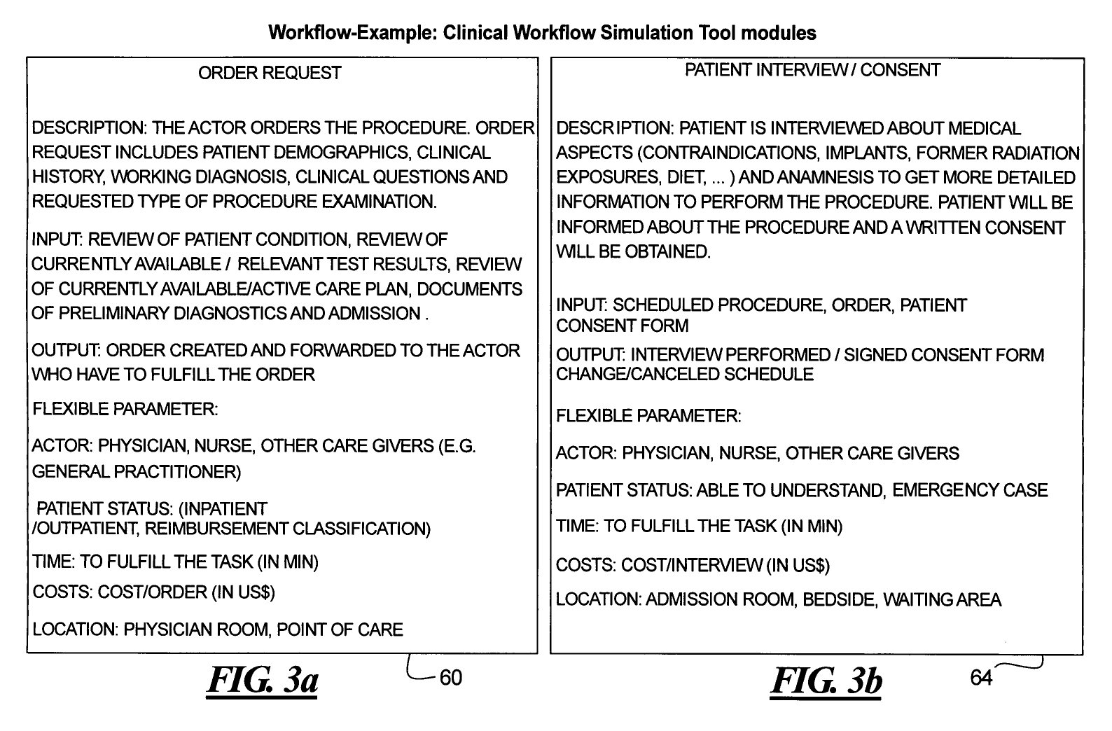

In FIGS. 3a and 3b are shown examples of two of the modules utilized iii the clinical workflow simulation. For instance, the order request module 60 is shown in FIG. 3a. In the order request module 60 is a description of the module which indicates that the actor (here the doctor) orders the procedures. The order request includes the patient demographics, the clinical history of the patient, the work diagnosis, the clinical questions, and an identification of the requested type of procedure or examination. The module 60 also includes an input section which indicates the input required for the module. Here it is that the patient condition is to be reviewed, as well as reviewing the currently available and relevant test results, reviewing the currently available and active care plan, and the documents of the preliminary diagnostics and admission. In the output section, an output from the module 60 calls for the output to be created and forwarded to the actors who have fulfilled the order or who will undertake a subsequent module under the flexible parameter indication, the actors may be a physician, nurse, or other care giver including for example, a general practitioner. Under patient status for the module, the patient may either be an in-patient, an out-patient, or in reimbursement classification. For the time indication, the time that is required to fulfill the task is indicated in minutes. For the cost parameter, the costs per order are indicated in U.S. dollars. For the location parameter, the physician room and point of care is indicated.

Another example of a module is the patient interview and consent module 64 shown in FIG. 3b. This module 64 includes as a description that a patient is interviewed about medical aspects of the patient's history and condition including, for example, contra-indications, implants, former radiation exposure, diet, and the like. An anamnesis is provided to get more detailed information to perform the procedures. The patient will be informed about the procedure and a written consent is obtained. The input to the module 64 is the scheduled procedure, the order, and the patient consent form. The output of the module 64 is an indication that the interview with the patient has been performed and a signed consent form obtained. Changes or cancellations in the schedule are also output. Under the flexible parameter indication, the actor for the module may either be the physician, nurse, or other care giver. The patient status is that the patient must be able to understand the information being given concerning the care. The module relieves the care giver of confirming that the patient can understand the information in the event of emergency care. The time parameter is indicated as the time to fulfill the task in minutes. The cost parameter is the cost of per interview in U.S. dollars. And the location indicator for the module 64 is either the admission room, the patient bed side, or the waiting area.

Each module has a description, an input, an output, and a flexible parameter set which indicates the time, cost and actors. It is foreseeable that some modules may be reused in a workflow or in other workflows. For instance, a patient transport module may be required in many different workflows.

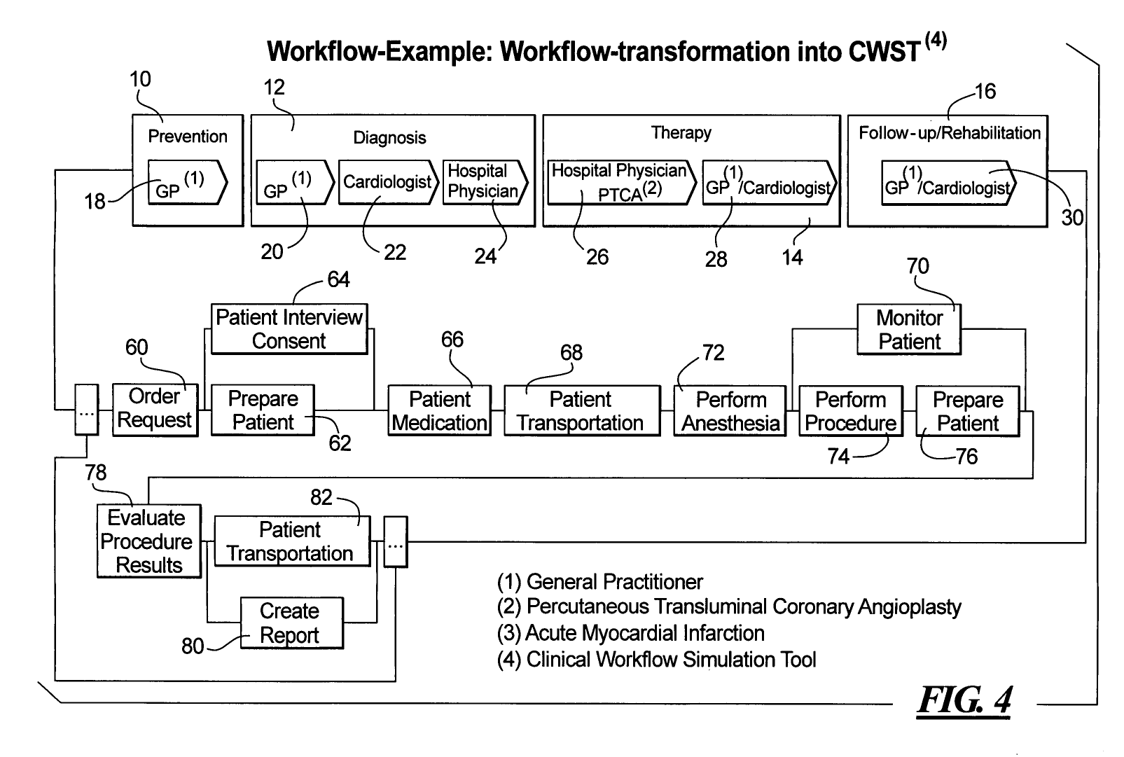

Once the modules are established and arranged according to the facility workflow as indicated in FIG. 4, the set of modules is transferred to the clinical workflow simulation tool. The workflow simulation tool is run as a simulated process as shown in FIG. 4. The major steps 10-16 and sub-processes 18-30 indicated in the previous figures are indicated in the upper portions of the figure. The detailed modules which constitute the hospital physician PTCA step are indicated in the illustrated example as including the order request module 60, the patient interview and consent module 64, the prepared patient module 62, the patient medication module 66, the patient transportation module 68, the perform anesthesia module 72, the monitor patient module 70, the perform procedure module 74, the prepare patient module 76, the evaluate procedure results module 78, the create report module 80, and the patient transportation module 82.

In running the simulation, the actors for each module, the location in the healthcare facility and other factors, many of which are specific to the healthcare facility, are taken into account. The simulation not only involves simulating a single workflow but also simulating workflows of other processes taking place at the healthcare facility so that interactions between workflows is simulated.

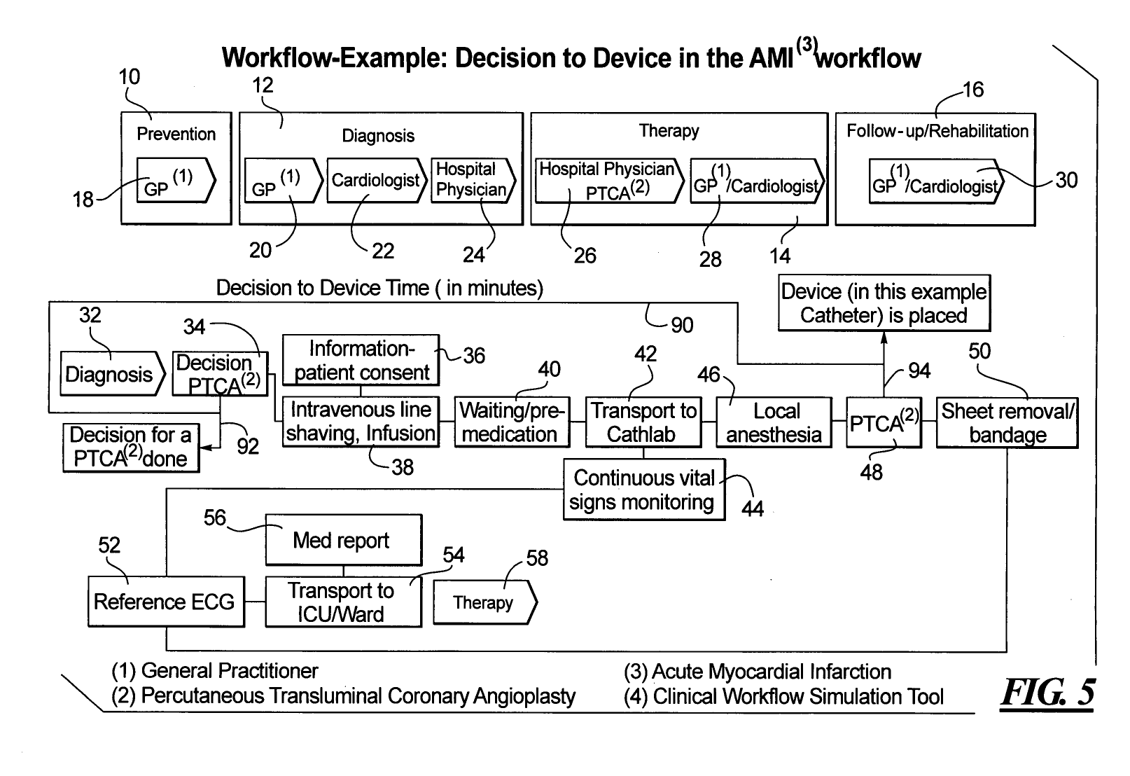

Once the clinical workflow is modeled in the system, it is now possible to measure parameters within the workflow. For instance, the FIG. 5 illustrates a measurement of a time within the workflow referred to as the decision to device time 90 A time indication 92 is taken as to when the decision is made to install the percutaneous transluminal coronary angioplasty device, and the amount of time which passes in the process until the catheter device is in place 94 is measured in minutes. This measurement 90 can be compared to ideal times or times for other facilities, but is preferably used as a measure of performance for this facility.

Relevant parameters based on clinical, operational or financial questions can be defined in the healthcare facility workflow. Various questions can be answered and variations in parameters are possible.

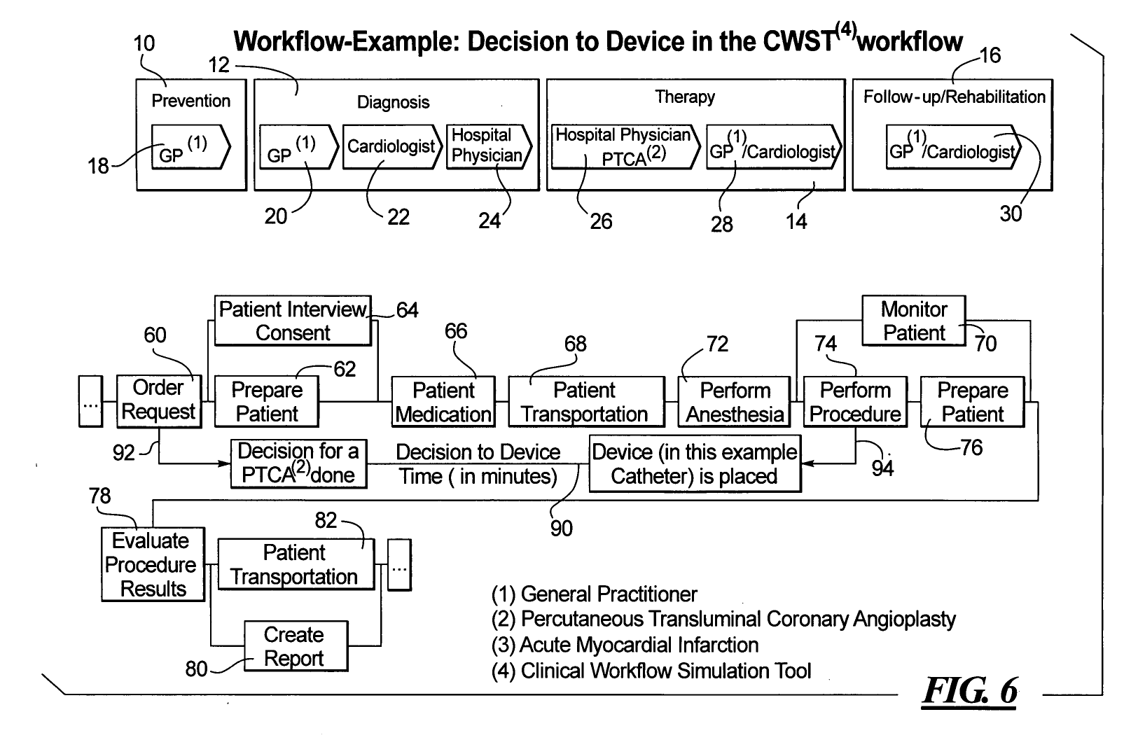

FIG. 6 illustrates the transformation of the clinical workflow simulation of FIG. 1 to the module layout of FIG. 4. The decision to device time in minutes parameter 90 as indicated in this modular workflow including the time indicators 92 and 94 at the modules 60 and 72.

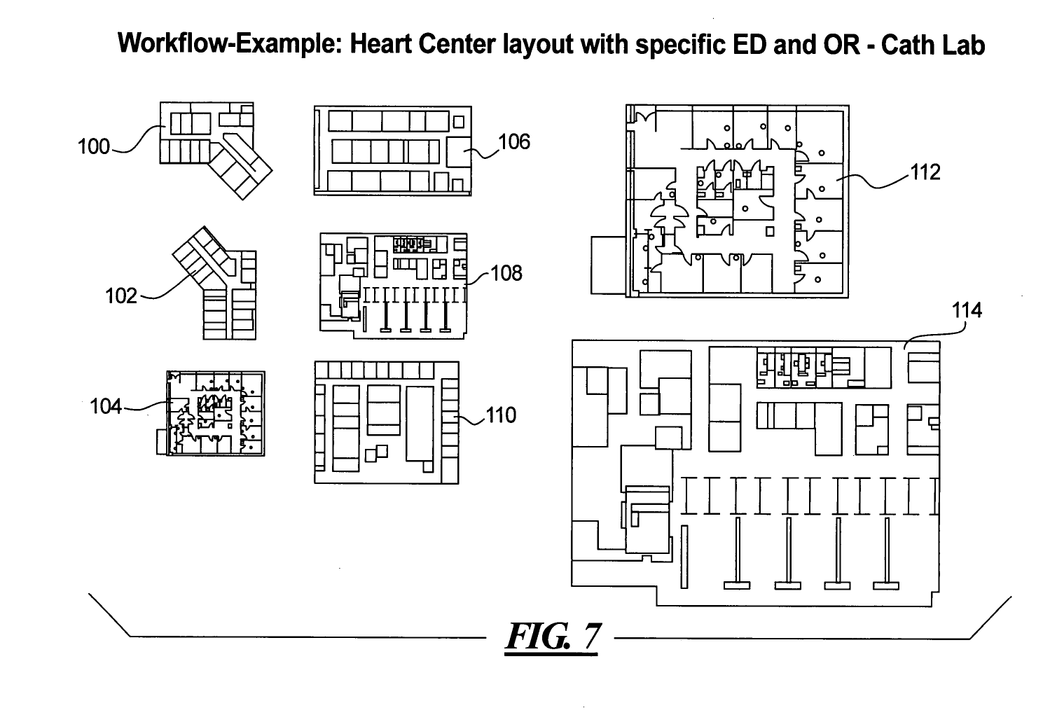

In FIG. 7 is a grouping of floor plans or layouts 100, 102, 104, 106, 108, 110, 112, and 114 for various labs, departments and facilities in the healthcare center which are involved in the performance of the modules of FIG. 6. Locations of equipment and offices and indications of passageways, doors, and stairs are marked for determination of relative position, time of travel for patients and staff and other aspects in the patient care. The floor plans or layouts are input into the simulation tool. The layouts are provided for use in a run time animation for mapping into the clinical workflow simulation tool. The illustrated example is the floor plan for a heart center having an emergency facility, a radiology department 110, an operating room and cathlab facility 108 and in enlarged view at 114, an intensive care unit 106, an intermediate care unit 102, and a patient ward 100. The maps are used to map the hospital layout and assign resources to the process steps and give time periods for performance of the process steps as well as to assign workplaces to the process steps and assign patients to the process steps. Interferences in the process steps can be defined using the maps, for instance.

Multiple workflows are incorporated into the clinical workflow simulation, adding each in much the same way as described above. After all of the workflows are added, the simulation is run. As the result, complex process interactions between different patient processes can be simulated and analyzed. For example, the interaction between the care for acute myocardial infarction patients and care for stroke patients in the emergency department is simulated and analyzed. Interferences between these two care procedures are located and changes in the parameters inserted in attempts to reduce the interferences.

According to a preferred embodiment, the clinical workflow simulation tool runs the workflows for different patients over longer periods of time including over weeks or years. This permits long term problems to be analyzed.

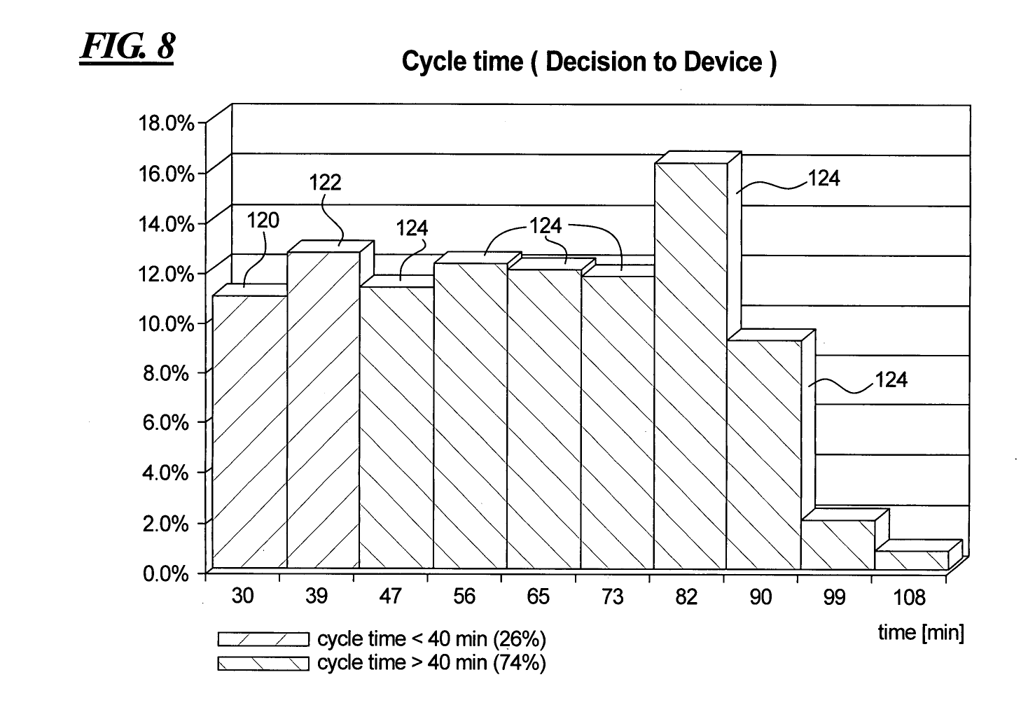

Parameters are analyzed for the existing system. For instance, a question may arise as to the time required for an acute myocardial infarction patient to proceed from decision to device. In other words, how long passes from the time that a decision is made that the patient needs a heart stent or similar device until the device is actually in the patient. The data for this measurement is displayed graphically, for example, as shown in FIG. 8. The number of patients for each time interval is indicated as a bar on the bar graph and the question can be asked as to how many patients are receiving treatment from decision to device within a forty minute time interval. According to the light colored bars 120 and 122 on the graph, only a small percentage of the patients receive this prompt care. The dark colored bars 124 indicate that treatment for far more patients is requiring a greater length of time.

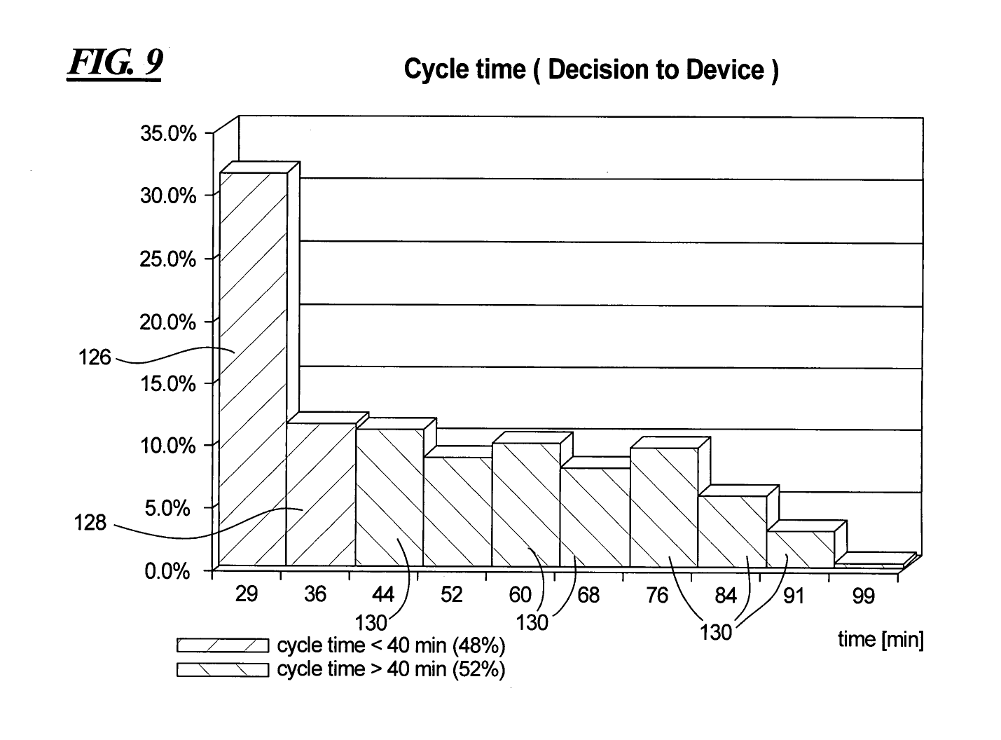

The simulation provided by the present method and system enables various aspects of the workflow and the facility to be changed in the model without making a physical change in the facility. For instance, the operating room or cathlab may be moved closer to the emergency unit or at least placed on the same floor if they are on different floors. Processes may be analyzed to discover correctable changes by changing staffing, facilities, equipment and layout, or other characteristics of the facility. These changes can be modeled in the simulation and displayed as a comparable output as indicated, for example, in FIG. 9. By making changes in the simulation, a decision to device cycle time shows a dramatic improvement in the number of acute myocardial infarction patients receiving treatment in under forty minutes. The number of patients receiving the treatment in under 40 minutes is indicated by the light colored bars 126 and 128 while the now fewer patients reviewing the treatment in longer than 40 minutes is indicated by the bars 130. By comparing FIGS. 8 and 9, an improvement in the under forth minute cycle time of from 26% to 48% is realized. Such changes in various parameters may be tested without physical change to the facility and thereby provide direct feedback on the effectiveness of the change. Furthermore, the simulation is modeled on the actual healthcare facility being considered. The clinical workflow simulation tool and method saves time and money for the healthcare facility by giving direct feedback as the result of process changes. The clinical workflow simulation helps to see interaction between different processes and system reactions.

In various embodiments, the user may change the processes so that the healthcare facility uses electronic records rather than paper records, so that time is saved which could be spent in looking through papers to find particular records. Another change contemplated might be a change in the layout of the hospital so that the radiology department is rebuilt on the same floor as the operating room and so can save transport time as measured in minutes. Resources may be accounted for so that an electronic scheduling system for scheduling, for example, x-rays or CAT scans, is provided for the various facilities rather than providing clerks to do this job. The simulation tool can compare the cost for each structure with the differences in procedure time for patient throughput.

The outputs of the various parameters may be indicated in a variety of formats. For example, it is contemplated to utilized time graphs, distribution graphs, cost distribution graphs, or alphanumeric tables as the specific output. The outputs can be displayed on a computer display, printed on paper, or otherwise made available for consideration. The processes may be animated in a virtual world for the real healthcare environment. Following the analysis of the processes and a determination of the proposed changes in the operation of the hospital depending on the healthcare facility layout map with its resources modeled in a real scenario in a real day and night simulation run over months or years, these proposed changes may be implemented with some confidence that they will account for real savings in patient care and costs.

An advantage of the present simulation is that the healthcare facility can run the simulation and compare it compare directly to the actual operation of the healthcare facility to determine if the simulation is accurate. In this way, inaccuracies can be discovered and corrected to ensure that the simulation is an accurate representation of the actual performance of the healthcare facility. This adds confidence that the modeling after input of the proposed changes will translate into actual improvements when these changes are made in physical facility.

The present method and system may be utilized as a demonstration tool to explain workflow consulting projects and to show output examples for improvements in prospects to healthcare facilities. The simulation may be utilized to provide a baseline for healthcare facility workflows to aid a consultant during an initial setup of a consulting project. In the concept phase, the present simulation can compare different approaches and find the best fit in view of the operational and financial parameters of the particular healthcare facility. The proposals may be measured as to their performance parameters in the re-engineered processes. Further, the simulation may be utilized during the implementation of the changes to anticipate unexpected changes in the workflow.

Thus, the present method and system provides a simulation of a clinical workflow in a healthcare facility which models the processes and treatment of patients and enables various processes to be compared and shown in interaction with one another. Actual data from the healthcare facility is provided as input. Proposals for changing the performance parameters in the re-engineered processes may be measured.

Although other modifications and changes may be suggested by those skilled in the art, it is the intention of the inventors to embody within the patent warranted hereon all changes and modifications as reasonably and properly come within the scope of their contribution to the art.

We claim:

1. A workflow simulation tool for a healthcare facility, comprising:
software stored on a computer readable medium and operable on a computer to perform the following steps:
inputting data gathered from measurements of the healthcare facility;
inputting layout data of the healthcare facility;
generating a clinical workflow for each of a plurality of patient treatments, said clinical workflows each including a plurality of patient treatment steps;
establishing modules for each of said patient treatment steps, each of said modules including an input and an output and at least one actor and work steps performed by the at least one actor and location information in the healthcare facility;
linking said modules to one another according to said patient treatment steps of said plurality of patient treatments to form an ordered set of modules; and
running a workflow simulation based on said ordered set of modules, said running of said workflow simulation taking into account the actors for each module and location in the healthcare facility.

2. A method for workflow simulation in a healthcare facility, comprising the steps of:
inputting data gathered from measurements of the healthcare facility;
inputting layout data of the healthcare facility;
generating a clinical workflow for each of a plurality of patient treatments, said clinical workflows each including a plurality of patient treatment steps;
establishing modules for each of said patient treatment steps, each of said modules including an input and an output and at least one actor and work steps performed by the at least one actor and location information in the healthcare facility;
linking said modules to one another according to said patient treatment steps of said plurality of patient treatments to form an ordered set of modules; and
running a workflow simulation based on said ordered set of modules, said running of said workflow simulation taking into account the actors for each module and location in the healthcare facility.

3. A method as claimed in claim 2, further comprising the step of:
measuring a performance parameter in said running of the workflow simulation.

4. A method as claimed in claim 3, wherein said running of the workflow simulation is a first simulation, and further comprising the steps of:
receiving proposed changes in data of the healthcare facility;
running a second workflow simulation with the proposed changes; and
measuring a performance parameter of said second simulation.

5. A method as claimed in claim 4, further comprising the steps of:
displaying a comparison of the performance parameter of the first simulation to the performance parameter of the second simulation.

6. A method as claimed in claim 2, wherein said clinical workflow includes stages each assigned to medical professionals.

7. A method for simulating a healthcare facility, comprising the steps of:
gathering data on operational and financial parameters of the healthcare facility;
inputting the operational and financial parameters to a simulation;
inputting floor plan data and equipment data of the healthcare facility to the simulation;
generating a clinical workflow for each of a plurality of patient treatments performed by the healthcare facility, each of said clinical workflows corresponding to a type of patient treatment performed by the healthcare facility;
identifying steps in each of said clinical workflows, said steps being logical divisions of the patient treatment;
assigning modules to each of said steps, said modules including an identification of at least an input required by the module and an output provided by the module and work to be performed in the module and at least one actor to perform the work and a location in the healthcare facility for performing the work;
linking said modules for each of said steps to one another in accordance with said steps in each of said clinical workflows;
running a simulation of said linked modules for all of said clinical workflows, said simulation taking into consideration at least one of locations of equipment and travel times of the actors throughout the workflows and interactions of the workflows with one another;
outputting performance parameters of the workflows from the simulation;
accepting proposed changes in at least one of the operational and financial parameters and floor plan data and equipment data as changed input to the simulation;
running the simulation with the changed input data; and
outputting performance parameters of the simulation with the changed input data.

8. A method as claimed in claim 7, further comprising the step of:
comparing the performance parameters of the simulation with actual performance parameters of the healthcare facility.

9. A method as claimed in claim 8, further comprising the step of:
correcting the simulation as needed so that the performance parameters of the simulation to correspond to the actual performance parameters of the healthcare facility.

10. A method as claimed in claim 7, further comprising the step of:
implementing changes in the healthcare facility in accordance with the proposed changes.

11. A method as claimed in claim 7, wherein said proposed changes include at least one of layout of the healthcare facility, changes in staffing, and changes in technology used for the steps.
